(19) United States
(12) Patent Application Publication
(10) Pub. No.: US 2026/0149936 A1
(43) Pub. Date: May 28, 2026

(54) SIGNAL ENHANCEMENT USING A NOISE REDUCTION CONNECTIVITY METHOD

(71) Applicant: Oticon A/S, Smørum (DK)

(72) Inventor: Lars RIEMER, Smørum (DK)

(21) Appl. No.: 19/377,091

(22) Filed: Nov. 3, 2025

(30) Foreign Application Priority Data
Nov. 26, 2024 (EP) 24215413.6

(51) Int. Cl. H04R 25/00

(52) U.S. Cl. CPC H04R 25/453; H04R 25/554; H04R 2225/49

(57) ABSTRACT

Disclosed herein are embodiments of a method of signal enhancing using noise reduction connectivity is disclosed. The disclosure may be used in a hearing aid receiving an external signal from an external device, wherein the external signal includes a description of a noise produced by a noisy device in the surrounding of the hearing aid. The hearing aid can include a processor for processing the input audio signal, based on the external signal to provide a noise reduced signal. The hearing aid can further include an output unit for outputting the noise reduced signal to the user.

### CROSS REFERENCE TO RELATED APPLICATIONS

Any and all applications for which a foreign or domestic priority claim is identified in the Application Data Sheet as filed with the present application are hereby incorporated by reference under 37 CFR 1.57.

### TECHNICAL FIELD

The present application relates to the field of hearing aids.

### BACKGROUND

Hearing aids face challenges in improving speech intelligibility, speech quality of a target speaker, and noise reduction. Various powered household devices create a lot of noise. A hearing aid user will get the noise amplified along with all other sounds, making bad hearing worse. Many other sound sources can either be wanted, or noise. People talking to you are a wanted signal, but people talking to other are typically noise. A hearing aid user has huge problems in the “cocktail party” scenario. There are several noise reduction methods known, such as beamforming, which may be used to improve the audio quality of a desired sound signal in general. Several beamforming implementations have been provided in the prior art, however those are not based on the difference in travelling time between sound and electromagnetic radiation.

### SUMMARY

The present disclosure deals with hearing aids; with a system comprising a hearing aid and an external device for transmitting an external signal, wherein the external signal comprises a description of a noise produced by a noisy device in the surrounding of the hearing aid; and with a method of noise reduction in a hearing aid, the method for being implemented by the system. Embodiments of the present disclosure relate to noise reduction connectivity.

In an aspect of the present application, a hearing aid for implementing a noise reduction connectivity method is provided. The hearing aid may comprise an input unit for providing an input audio signal indicative of a surrounding of the hearing aid. The hearing aid may comprise a communication interface for receiving an external signal from an external device, wherein the external signal comprises a description of a noise produced by a noisy device in the surrounding of the hearing aid. The hearing aid may comprise a processor for processing the input audio signal, based on the external signal, to provide a noise reduced signal. The hearing aid may comprise an output unit for outputting the noise reduced signal to the user.

Thereby an improved hearing aid may be provided.

The input unit may comprise an input transducer, e.g. a microphone, to transform acoustic and/or vibrational energy into electric energy and for providing an electric signal in the time domain representing sound. The input unit may comprise an analysis filter bank to transform said electric signal from the time domain to the time-frequency domain. The input unit may comprise a wireless receiver for receiving a wireless signal comprising or representing sound and for providing an electric signal representing said sound.

The communication interface may comprise a wireless receiver and/or a wireless transducer for receiving the external signal from the external device. The wireless receiver and/or transmitter may e.g. be configured to receive and/or transmit an electromagnetic signal in the radio frequency range (3 kHz to 300 GHz). The wireless receiver and/or transmitter may e.g. be configured to receive and/or transmit an electromagnetic signal in a frequency range of light (e.g. infrared light 300 GHz to 430 THz, or visible light, e.g. 430 THz to 770 THz).

The hearing aid may comprise antenna and transceiver circuitry allowing a wireless link to an entertainment device (e.g. a TV-set), a communication device (e.g. a telephone), a wireless microphone, a separate (external) processing device, or another hearing aid, etc. The hearing aid may thus be configured to wirelessly receive a direct electric signal from another device. Likewise, the hearing aid may be configured to wirelessly transmit a direct electric signal to another device. The direct electric signal may represent or comprise an audio signal and/or a control signal and/or an information signal.

In general, a wireless link established by antenna and transceiver circuitry of the hearing aid can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy (BLE) technology, e.g. LE audio), or Ultra WideBand (UWB) technology.

The processor may be configured to estimate a delay difference between the input audio signal and the external signal; and process the input audio signal, based on the external signal and the delay difference, to provide the noise reduced signal. The description of the noise may comprise one or more of the following: a sampling of the noise, a transform of the noise, a noise spectrum, one or more coordinates of the noise, a noise intensity, and ranging information.

The processor may be configured to determine a noise frequency based on the external signal, and to mute the noise frequency in the input audio signal. The processor may be configured to subtract at least part of the external signal from the input audio signal.

The input unit and the processor may be configured to receive a calibration audio signal, and/or a calibration electromagnetic signal, from the external device; mute or attenuate the calibration audio signal to the user; and use the calibration audio signal to fine-tune the processing of the input audio signal.

The hearing aid may be constituted by or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g, such as less than 5 g.

The output unit may comprise a synthesis filter bank for transforming the noise reduced signal from the frequency-time domain to the time domain. The output unit may comprise an output transducer, e.g. a speaker, for providing a stimulus perceived by the user as sound, e.g. acoustic vibration (e.g. in air), based on the noise reduced signal (in the time-domain). The output unit may comprise a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation).

The external device may comprise one or more of the following: a TV, a sound system, a smartphone, a dishwasher, a hand mixer, a gas or oil furnace, a toilet flushing, a keyboard typing, a ventilation system, and a chair moving.

The hearing aid may comprise other relevant functionality for the application in question, e.g. noise reduction, connectivity, etc.

The hearing aid may comprise a hearing instrument, e.g. a hearing instrument adapted for being located at the ear or fully or partially in the ear canal of a user.

In an aspect of the present disclosure, a binaural hearing system comprising left and right hearing devices adapted for being located at or in left and right ears of a user, defined in claim 1. We will describe the disclosure according to an embodiment comprising a single hearing aid. However, we are aware that an embodiment comprising a binaural hearing aid may be also covered by the present disclosure.

In an aspect, a hearing system comprising a hearing aid as described above, in the ‘detailed description of embodiments’, and in the claims, and an external device is moreover provided.

The system may comprise a hearing aid as described above, and an external device for transmitting an external signal, wherein the external signal comprises a description of a noise produced by a noisy device in the surrounding of the hearing aid.

The hearing system may be adapted to establish a communication link between the hearing aid and the external device to provide that information (e.g. control and status signals, the external signal comprising a description of a noise produced by a noisy device in the surrounding of the hearing aid, possibly audio signals and electromagnetic signals) can be exchanged or forwarded from one to the other.

The external device may be constituted by or comprise an audio gateway device adapted for receiving a multitude of audio signals (e.g. from an entertainment device, e.g. a TV or a music player, a telephone apparatus, e.g. a mobile telephone or a computer, e.g. a PC, a wireless microphone, etc.) and adapted for selecting and/or combining an appropriate one of the received audio signals (or combination of signals) for transmission to the hearing aid.

The external device may comprise a movable device comprising an external input unit for providing the external signal indicative of a surrounding of the external device. This option allows the user to freely place the external device in a desired, strategically chosen position in order to get the external signal coming from the desired noisy device. This solution allows the user to get noise reduction from already bought devices.

The external device may comprise an input transducer for providing the external signal. That may be useful, for example, when the external device comprises a movable device to be placed on/in a noisy device, on someone, or on the vicinity of a noisy device, crowd or animal/s.

The external device and the hearing aid are designed for sending and/or receiving the external signal via Bluetooth low energy (BLE) or ultra-wideband (UWB).

The external device may be designed for estimating a distance between the external device and the hearing aid, communicating with the hearing aid if the distance is smaller than a threshold distance, and not transmitting the external signal if the distance is smaller than the threshold distance. That may be relevant, as the method disclosed below requires a time difference between the moment in which the hearing aid detects the external signal comprising a description of a noise produced by a noise device in the surrounding of the hearing aid and the moment in which the hearing aid detects the noise produced by the noisy device in the surrounding of the hearing aid. Therefore, if the hearing aid and the external device are very close, the time difference may be so small that the method may not work, and thus in that case it may be more convenient to not transmit the external signal, which may result in saving power.

In an aspect of the present disclosure a method is provided. The method of noise reduction in a hearing aid, comprises providing an input audio signal indicative of a surrounding of the hearing aid; receiving an external signal from an external device, wherein the external signal comprises a description of a noise produced by a noisy device in the surrounding of the hearing device; processing the input audio signal, based on the external signal, to provide a noise reduced signal; and outputting the noise reduced signal to the user.

It is intended that some or all of the structural features of the device described above, in the ‘detailed description of embodiments’or in the claims can be combined with embodiments of the method, when appropriately substituted by a corresponding process and vice versa. Embodiments of the method have the same advantages as the corresponding devices.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 schematically shows a first embodiment of a system according to the present disclosure, the system comprising a hearing aid and an external device;

FIG. 2A schematically shows a second embodiment of the present disclosure, and where the system comprises a binaural hearing system, and where the external device comprises a TV and a movable device, the movable device comprising an external input unit; and

FIG. 2B schematically shows a second embodiment of the present disclosure, and where the system comprises a binaural hearing system, and where the external device comprises a refrigerator and a movable device, the movable device comprising an external input unit.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears and/or acoustic signals transferred as mechanical vibrations to the user's inner ears through the bone structure of the user's head and/or through parts of the middle ear.

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g. a music player, a wireless communication device, e.g. a mobile phone (such as a smartphone) or a tablet or another device, e.g. comprising a graphical interface. Hearing aids, hearing systems or binaural hearing systems may e.g. be used for compensating for a hearing-impaired person's loss of hearing capability, augmenting or protecting a normal-hearing person's hearing capability and/or conveying electronic audio signals to a person. Hearing aids or hearing systems may e.g. form part of or interact with public-address systems, active ear protection systems, handsfree telephone systems, car audio systems, entertainment (e.g. TV, music playing or karaoke) systems, teleconferencing systems, classroom amplification systems, etc.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

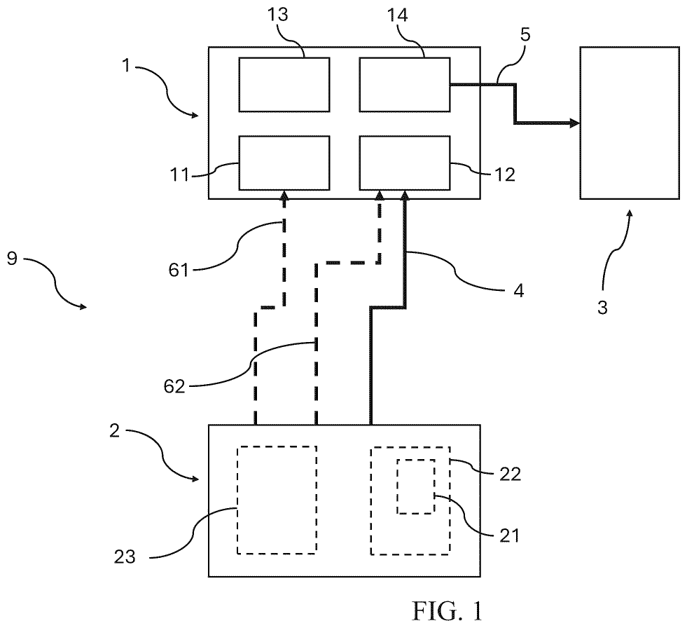

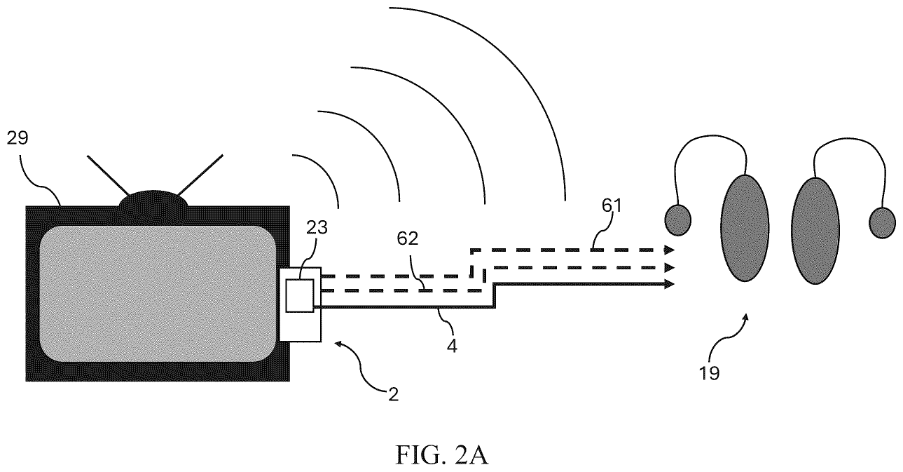

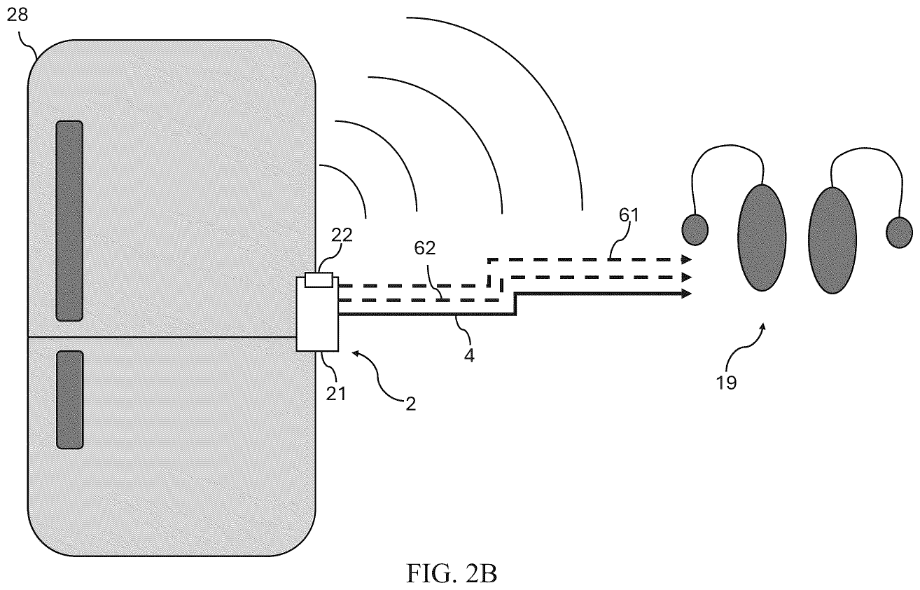

The general idea of the disclosure, shown in FIG. 1 and in FIGS. 2A-2B, comprises an external device 2 sending out a description of a noise produced by a noise device, so that the hearing aid 1 can subtract or reduce that noise from the incoming sound. By “noise” it may be understood as any unwanted sound produced by an audio source, e.g. a TV, sound systems or music from a smartphone. The previous examples (a TV, sound systems or music from a smartphone) are examples of audio sources that may produce wanted sound but also unwanted sound. The present disclosure may allow for an adaptive noise reduction depending on whether the audio produced is wanted or unwanted. Note that in some embodiments the external device 2 may comprise the noise device, e.g. a TV 29, a refrigerator 28, a ventilator, etc. Note that in some embodiments the external device 2 may not comprise the noise device, e.g. in the embodiment wherein the external device 2 comprises a movable device 22 comprising an external input unit 21 to be placed in a strategic position of a room to provide an external signal 4 comprising a description of a noise produced by a noisy device in the surrounding of the hearing aid 1.

FIG. 1 schematically shows a first embodiment of a system according to the present disclosure, the system comprising a hearing aid and an external device.

For the purpose of describing the disclosure, the following constants may be defined: the speed of light c=299792458 m/s and the speed of sound in the air v=343 m/s. Note that the value of c implies that for events taking place at distances under 500 km, the time that electromagnetic radiation needs to reach an observer located at 500 km is lower than 10 ms (a typical latency time of a hearing aid), and thus one can assume that for events occurring at distances under 500 km from an observer the electromagnetic time-lapse is negligible. However, for sound in the air, in order to have a negligible acoustic time-lapses, e.g. 10 ms, it is only required that the distance between the observer and the event is greater than 3.43 m. Therefore, for events occurring at a distance between 3.43 m and 500 km, it may be possible for a hearing aid to detect electromagnetic signals originated in such events before detecting sound originated in the same event. We can then define a threshold distance to be 3.43 m from which the disclosure may be implemented. Depending on the actual latency time of the hearing aid, other threshold distances may be defined, such as 1.5 m, 2 m, 4 m, or 6 m. A surrounding area of a hearing aid may be understood as any position located at a distance greater than the threshold distance, e.g. 3.43 m, and lower than 1 km, which is a reasonable horizon for events that cannot be heard, or, in case that the event can be heard despite being than 1 km from the observer, the event may be so dangerous that the observer may also want to listened it without cancelling it as if it was noise.

In the embodiment depicted in FIG. 1, a system 9 comprising a hearing aid 1 and an external device 2 located in a surrounding area of the hearing aid 1. The hearing aid 1 is worn by a user 3.

In the embodiment of FIG. 1, the hearing aid 1 comprises an input unit 11 for providing an input audio signal indicative of a surrounding of the hearing aid 1. The input unit 11 may comprise an input transducer, e.g. a microphone, to transform acoustic and/or vibrational energy into electric energy and for providing an electric signal in the time domain representing sound. The input unit 11 may comprise an analysis filter bank to transform said electric signal from the time domain to the time-frequency domain. In an embodiment, the input unit 11 may comprise more than one input transducers, e.g. microphones, and a beamforming filter may be applied. Beamforming filters are described in the prior art.

In the embodiment of FIG. 1, the hearing aid 1 comprises a communication interface 12 for receiving an external signal 4 from an external device 2, wherein the external signal 4 comprises a description of a noise produced by a noisy device in the surrounding of the hearing aid 1. The communication interface 12 may comprise a wireless receiver for wirelessly receiving the external signal 4 comprising or representing sound and for providing an electric signal representing said sound. The external signal 4 may be sent electromagnetically. The external signal 4 may be sent using BLE. The external signal 4 may be sent using UWB. The external signal 4 may be received at the communication interface 12 of the hearing aid 1 before the noise reaches the input unit 11 of the hearing aid 1 through the air. The external signal 4 may comprise one or more of the following: a live sampling of the noise as detected by the external device 2, some transformation of the live noise (e.g. a Fast Fourier Transform or a data-compression of the noise), a typical noise spectrum which may be defined at manufacturing time (in case the external device 2 comprises the noisy device). The external signal 4 may comprise coordinates, distance and/or position of the external device 4 in a local system for being used by the processor 13. The external signal 4 may comprise signal strength information of the noise produced by a noisy device in the surrounding of the hearing aid 1 for being used by the processor 13. The external signal 4 may comprise UWB ranging information of the external signal 4 for being used by the processor 13. The communication interface 12 may be provided as antenna and transceiver circuitry for establishing an audio communication link according to a standardized of proprietary (short range) protocol.

In the embodiment of FIG. 1, the hearing aid 1 comprises a processor 13 for processing the input audio signal, based on the external signal 4, to provide a noise reduced signal 5. The processor 13 may also be designed for compensating for a hearing impairment of a user 3 of the hearing aid 1. The noise reduction performed by the processor 13 allows the hearing aid 1 to enhance the signal-to-noise ratio of the noise reduced signal 5 with respect to the signal-to-noise ratio of the input audio signal. The noise reduction may be implemented in different ways. The noise reduction may be implemented by muting the noisy frequencies, if the external signal 4 comprises a description of the noise, the description of the noise comprising the noisy frequencies. The noise reduction may be implemented by subtracting the actual noise from the audio signal received by the input unit 11 of the hearing aid 1, if the external signal 4 comprises a description of the noise, the description of the noise comprising the actual noise signal. The one or more processing algorithms implemented by the processor 13 may e.g. comprise a compression algorithm configured to amplify (or attenuate) a signal according to the needs of the user, e.g. to compensate for a hearing impairment of the user. Other processing algorithms may include frequency transposition, feedback control, etc. The processor 13 provides a processed output that is fed to a synthesis filter bank for conversion from the time-frequency representation (frequency domain) to the time domain. Time domain output signal is fed to an output unit 14 for conversion to stimuli perceivable by the user as sound, e.g. acoustic vibrations (e.g. in air)). The processor 13 may e.g. be configured to compensate for a hearing impairment of the user 3 (e.g. by applying a compressive amplification algorithm, e.g. providing a frequency and/or level dependent gain (or attenuation) to be applied to the input audio signal.

In the embodiment of FIG. 1, the hearing aid 1 comprises an output unit 14 for outputting the noise reduced signal 5 to the user 3. The output unit 14 may comprise a synthesis filter bank for transforming the noise reduced signal 5 from the frequency-time domain to the time domain. The output unit 14 may comprise an output transducer, e.g. a loudspeaker, for providing the noise reduced signal 5 to the user 3 through stimuli perceivable by the user 3 as sound. The input and output transducers may be individual separate components, or integrated (e.g. micro electromechanical systems (MEMS)-based) with another electronic circuitry.

In the embodiment of FIG. 1 a general hearing aid 1 is considered. The exemplary hearing aid 1, is of a particular style (sometimes termed receiver-in-the ear, or RITE, style) comprising a BTE-part (BTE) adapted for being located at or behind an ear of a user, and an ITE-part (ITE) adapted for being located in or at an ear canal of the user's ear and comprising a receiver (loudspeaker). The BTE-part and the ITE-part are connected (e.g. electrically connected) by a connecting element (IC) and internal wiring in the ITE-and BTE-parts (cf. e.g. wiring Wx in the BTE-part). The connecting element may alternatively be fully or partially constituted by a wireless link between the BTE-and ITE-parts (or by an acoustic tube, if the loudspeaker is located in the BTE-part). The hearing aid 1 may also cover a binaural hearing aid 19, as the one depicted in FIGS. 2A-2B.

In some embodiments, the external device 2 comprises a noisy device. In an embodiment in which the external device 2 comprises a noisy device, the external device 2 may send a calibration audio signal 61 through the air at turn-on or regularly to be received by the input unit 11 of the hearing aid 1. The calibration audio signal 61 may be muted to the user 3 by the processor 13. The calibration audio signal 61 may be used by the processor 13 to fine-tune the noise reduction by applying the noise reduction method only when the noisy device is on. In an embodiment in which the external device 2 comprises a noisy device, the external device 2 may send a calibration electromagnetic signal 62 air at turn-on or regularly to be received by the communication interface 12 of the hearing aid 1. The calibration electromagnetic signal 62 may be used by the processor 13 to fine-tune the noise reduction by applying the noise reduction method only when the noisy device is on.

FIG. 2A schematically shows a second embodiment of the present disclosure where the system 9 comprises a binaural hearing system 19, and where the external device 2 comprises a TV 29 and a movable device 22, the movable device 22 comprising an external input unit 21. FIG. 2B schematically shows a second embodiment of the present disclosure where the system 9 comprises a binaural hearing system 19, and where the external device 2 comprises a refrigerator 28 and a movable device 22, the movable device 22 comprising an external input unit 21.

In the embodiment of FIG. 2A, the external device 2 comprises a TV 29 (noisy device). The external device comprises a built-in input transducer 23 for providing the external signal 4 indicative of a surrounding of the external device 2. The built-in input transducer 23 may be configured from the manufacturer for either providing a predefined external signal 4 to the communication interface 12 of the binaural hearing aid 19. The built-in input transducer 23 may comprise an input unit for providing the external signal 4 to the communication interface 12 of the binaural hearing aid 19. The TV 29 may be located at the house of a neighbor of the binaural hearing aid 19 user, and therefore the sound produced by the TV 29 may be unwanted sound. The TV 29 may be located at the house of the binaural hearing aid 19 user, and the sound produced by the TV 29 may be unwanted sound (if the user is not actively watching the TV 29) or wanted sound (if the user is actively watching the TV 29). The user may be able to configurate if the sound is wanted sound or unwanted sound in any one of the ways known in the prior art, e.g. using an additional device like a smartphone with an APP connected to the binaural hearing aid 19. The TV 29 may send a calibration audio signal 61 through the air at turn-on or regularly to be received by the input unit 11 of the binaural hearing aid 19. The calibration audio signal 61 may be muted to the user 3 by the processor 13. The calibration audio signal 61 may be used by the processor 13 to fine-tune the noise reduction by applying the noise reduction method only when the TV 29 is on. The TV 29 may send a calibration electromagnetic signal 62 air at turn-on or regularly to be received by the communication interface 12 of the binaural hearing aid 19. The calibration electromagnetic signal 62 may be used by the processor 13 to fine-tune the noise reduction by applying the noise reduction method only when the TV 29 is on. In other embodiments, the system may comprise a (monaural) hearing aid 1 instead of a binaural hearing aid 19, but the external device 2 may be the one described in the embodiment of FIG. 2A. This “built-in” solution allows the external device 2 developer to place the input transducer 23 strategically for a better noise pickup, and control on/off.

In an embodiment, the external device 2 comprises a movable device 21 comprising an external input unit 22 for providing the external signal 4 indicative of a surrounding of the external device 2, wherein the movable device 21 is placed on the walls of the house of the user 3 of the hearing aid 1 for providing the external signal 4 indicative of the noise coming from the neighbor's house. This solution allows the user to get noise reduction from already bought devices. In that embodiment, the external input unit 22 may record the noise coming through the wall and re-transmit this noise or a description of this noise as the external signal 4 to be received by the communication interface 12 of the hearing aid 1 before the actual noise arrives to the hearing aid 1. In that embodiment, noise coming from the neighbor's house and/or the neighbor's electromechanical devices could be reduced by the hearing aid 1. In other embodiments, the noise produced by cars, motorcycles, trains, or pedestrians outside of the house of the user 3 of the hearing aid 1 can also be made less intrusive by the disclosure. In such embodiment, the system 9 is the same as the one described for the previously described embodiment, but the noisy device is outside of a building, instead of being at the neighbor's house. In such embodiments, the movable device 22 may be placed next to a window or a wall close enough to the street to capture the noise produced by cars, motorcycles, trains, or pedestrians outside of the house of the user 3 of the hearing aid 1. Similarly, in other embodiments, the noisy device could be one or more of the following: a dishwasher, a hand blender, a TV, a gas or oil furnace, a flushing toilet, a typing keyboard, a music instrument, a refrigerator, a sound system, a smartphone, a ventilation system, and a chair moving.

In the embodiment of FIG. 2B, the external device 2 comprises a refrigerator 28 (noisy device). The external device comprises a movable device 21 comprising an external input unit 22 for providing the external signal 4 indicative of a surrounding of the external device 2 to the communication interface 12 of the hearing aid 1. The refrigerator 28 may be located at the house of the binaural hearing aid 19 user. The refrigerator 28 may send a calibration audio signal 61 through the air at turn-on or regularly to be received by the input unit 11 of the binaural hearing aid 19. The calibration audio signal 61 may be muted to the user 3 by the processor 13. The calibration audio signal 61 may be used by the processor 13 to fine-tune the noise reduction by applying the noise reduction method only when the refrigerator 28 is consuming a higher power than usually for cooling and thus producing more noise than usually. The refrigerator 28 may send a calibration electromagnetic signal 62 air at turn-on or regularly to be received by the communication interface 12 of the binaural hearing aid 19. The calibration electromagnetic signal 62 may be used by the processor 13 to fine-tune the noise reduction by applying the noise reduction method only when the refrigerator 28 is consuming a higher power than usually for cooling and thus producing more noise than usually. In other embodiments, the system may comprise a (monaural) hearing aid 1 instead of a binaural hearing aid 19, but the external device 2 may be the one described in the embodiment of FIG. 2B.

The “built-in” solution exemplified in FIG. 2A may be cheaper and more effective than the “movable” solution exemplified in FIG. 2B but may add cost to every device produced. This may be partially countered by producing a device variant which has not got the “built-in” solution mounted nor tested. The “movable” solution may be more versatile but may need some sort of calibration or installation. Installation and calibration might be a barrier to adoption for some users but may be beneficial and optimal for other users.

In an embodiment, the system 9 comprises an external device 2 comprising a movable device 22 comprising an external input unit 21, and a hearing aid 1 configured to operate wirelessly connected to an additional device, e.g. a smartphone, the additional device being able to operate an APP as the ones described in the previous art, the system 9 allowing noisy colleagues or children appear quieter. The APP may also allow for a “privacy enhancement feature” making other people's voice reduce for the user 3 of the hearing aid 1 when e.g. talking on the phone.

The present disclosure may be beneficial for people without any hearing impairment. That could be the case, for example, in cases in which people are in very noisy environments, such as open-space offices or crowded social and/or cultural events like cinemas or museums. Therefore, many hearing aid manufacturers could benefit from implementing the disclosure, especially when coordinately implemented together with the manufacturers of potential external devices 2, such as electromechanical devices.

Apart from the (acoustic) output and input transducers, the hearing aid 1 may comprise other functional components, e.g. detectors, such as electrodes for picking up signals from the user's body (such as brainwave signals, temperature indications, blood-related parameters, heartbeat indications, muscular vibrations, etc.). Such detectors may include one or more of an electroencephalography (EEG) sensor, an electromyography (EMG) sensor, a movement sensor, a temperature sensor, a photoplethysmography (PPG) sensor, an electrooculography (EOG) sensor, etc.

The electric signals may be processed in the time domain or in the (time-) frequency domain (or partly in the time domain and partly in the frequency domain as considered advantageous for the application in question).

The embodiments of a hearing aid 1, exemplified in FIGS. 2A-2B are portable devices comprising a battery (BAT), e.g. a rechargeable battery, e.g. based on Li-Ion battery technology, e.g. for energizing electronic components of the BTE-and possibly ITE-parts. In an embodiment, the hearing device, e.g. a hearing aid, is adapted to provide a frequency dependent gain and/or a level dependent compression and/or a transposition (with or without frequency compression) of one or more frequency ranges to one or more other frequency ranges, e.g. to compensate for a hearing impairment of a user. The BTE-part may e.g. comprise a connector (e.g. a DAI or USB connector) for connecting a ‘shoe’ with added functionality (e.g. an FM-shoe or an extra battery, etc.), or a programming device, or a charger, or a separate processing device, etc., to the hearing aid 1.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. more, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. more, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” The term “some” refers to one or more.

1. A hearing aid comprising:
an input unit for providing an input audio signal indicative of a surrounding of the hearing aid;
a communication interface for receiving an external signal from an external device, wherein the external signal comprises a description of a noise produced by a noisy device in the surrounding of the hearing aid;
a processor for processing the input audio signal, based on the external signal, to provide a noise reduced signal; and
an output unit for outputting the noise reduced signal to the user.

2. A hearing aid according to claim 1, wherein the processor is configured to:
estimate a delay difference between the input audio signal and the external signal; and
process the input audio signal, based on the external signal and the delay difference, to provide the noise reduced signal.

3. A hearing aid according to claim 1, wherein the description of the noise comprises one or more of the following: a sampling of the noise, a transform of the noise, a noise spectrum, one or more coordinates of the noise, a noise intensity, and ranging information.

4. A hearing aid according to claim 1, wherein the processor is configured to:
determine a noise frequency based on the external signal; and
mute the noise frequency in the input audio signal.

5. A hearing aid according to claim 1, wherein the processor is configured to:
subtract at least part of the external signal from the input audio signal.

6. A hearing aid according to claim 1, wherein the input unit and the processor are configured to:
receive a calibration audio signal, and/or a calibration electromagnetic signal, from the external device;
mute or attenuate the calibration audio signal to the user; and
use the calibration audio signal, and/or the calibration electromagnetic signal to fine-tune the processing of the input audio signal.

7. A hearing aid according to claim 1, wherein the external device comprises one or more of the following: a TV, a refrigerator, a sound system, a smartphone, a dishwasher, a hand mixer, a gas or oil furnace, a toilet flushing, a keyboard typing, a ventilation system, and a chair moving.

8. A binaural hearing system comprising a left hearing aid according to claim 1 and a right hearing aid according to claim 1.

9. A system comprising:
a hearing aid according to claim 1; and
an external device for transmitting an external signal, wherein the external signal comprises a description of a noise produced by a noisy device in the surrounding of the hearing aid.

10. A system according to claim 9, wherein the external device comprises a movable device comprising an external input unit for providing the external signal indicative of a surrounding of the external device.

11. A system according to claim 9, wherein the external device comprises an input transducer for providing the external signal indicative of a surrounding of the external device.

12. A system according to claim 9, wherein the external device and the hearing aid are designed for sending and/or receiving the external signal via BLE or UWB.

13. A system according to claim 9, wherein the external device is designed for:
estimating a distance between the external device and the hearing aid,
communicating with the hearing aid if the distance is smaller than a threshold distance, and
not transmitting the external signal if the distance is smaller than the threshold distance.

14. A method of noise reduction in a hearing aid, the method comprising:
providing an input audio signal indicative of a surrounding of the hearing aid;
receiving an external signal from an external device, wherein the external signal comprises a description of a noise produced by a noisy device in the surrounding of the hearing aid;
processing the input audio signal, based on the external signal, to provide a noise reduced signal; and
outputting the noise reduced signal to the user.
